(19) United States
(12) Patent Application Publication
(10) Pub. No.: US 2017/0011308 A1
(43) Pub. Date: Jan. 12, 2017

(54) Methods and Systems for Applying Machine Learning to Automatically Solve Problems

(71) Applicant: SunView Software, Inc., Tampa, FL (US)

(72) Inventors: Seng Sun, Wesley Chapel, FL (US); Joshua Porth, Tampa, FL (US); George Panicker, Broomfield, CO (US); Kurt Kramer, St. Petersburg, FL (US); Daniel N. McNally, Tampa, FL (US)

(21) Appl. No.: 15/202,723

(22) Filed: Jul. 6, 2016

Related U.S. Application Data
(60) Provisional application No. 62/324,678, filed on Apr. 19, 2016.
(60) Provisional application No. 62/190,362, filed on Jul. 9, 2015.

(51) Int. Cl. G06N 99/00; G06F 3/0484; G06F 17/30

(52) U.S. Cl. CPC G06N 99/005; G06F 17/30598; G06F 3/04842

(57) ABSTRACT

A method for receiving a description of a problem and applying machine learning to automatically solve the problem includes receiving, by a first computing device, from a second computing device, via a user interface component, a description of a first problem. The method includes assigning, by a clustering engine executing on the first computing device, the first problem to a class. The method includes identifying, by a correlation engine executing on the first computing device, a first database associated with the class. The method includes retrieving, by the correlation engine, from the identified database, first data relevant to the first problem. The method includes providing, by the first computing device, via the user interface component, a suggestion for solving the first problem, based on the retrieved first data.

### CROSS-REFERENCE TO RELATED APPLICATIONS

This application claims priority from U.S. Provisional Patent Application Ser. No. 62/324,678, filed on Apr. 19, 2016, and entitled “Methods and Systems for Applying Machine Learning to Automatically Solving Problems” and from U.S. Provisional Patent Application Ser. No. 62/190,362, filed Jul. 9, 2015, and entitled “Methods and Systems for Automatically Solving Identified and Unidentified Problems,” each of which is hereby incorporated by reference.

### BACKGROUND

The disclosure relates to solving problems. More particularly, the methods and systems described herein relate to functionality for receiving a description of a problem and applying machine learning to automatically solve the problem.

Conventional systems for providing decision support are typically limited in the types of data accessible to the system and the types of decisions supported. Such systems typically have limited or no ability to infer problems to be solved, to identify related but unspecified problems, or to suggest solutions to either open-ended questions or to the unspecified problems that will assist with solving specified problems. Furthermore, conventional systems typically depend on human experts to manually identify a solution to a specific, factual or otherwise closed question, allowing a machine to later identify the solution when presented with the question.

Conventional systems may allow a user to select a problem from a series of problems and provide the user with text associated with one of the series of problems—for example, displaying a user interface in which the user may select a problem such as a problem with a piece of hardware from a list of problems, displaying a text file that a technical support representative previously associated with the problem, and suggesting that the user call a help desk if a review of the text does not solve the problem. However, such systems would not typically allow a user to enter, in their own words, their question or frustration, which may or may not be associated with a known problem. Furthermore, such systems would not typically allow a user to review actual solutions to similar problems that were resolved—only to view the text that was associated with a predefined problem. For example, if a user selects the text “keyboard does not work” from a set of predefined possible problems, a conventional system might search a table for the text “keyboard does not work” and determine whether there is a file associated with that text that the conventional system should display to the user. If the text displayed does not actually help the user and, in fact, has not helped any users with that problem, conventional systems are typically limited in their abilities to provide alternatives or to learn from previous users' dissatisfaction with the solution suggested, at most suggesting that the user contact a technical support representative.

Furthermore, conventional systems are typically limited to closed questions presenting clearly-defined problems with well-documented solutions—if a keyboard is not working, there are a set of well-known steps that may be associated with a resolution for the problem. However, such conventional systems typically fail to address open-ended questions without well-documented solutions. For example, questions such as “Why are sales of ABC product down this quarter?” or “Why did technical support calls go up in October?” are rarely addressed by conventional systems.

### SUMMARY

In one aspect, a method for receiving a description of a problem and applying machine learning to automatically solve the problem includes receiving, by a first computing device, from a second computing device, via a user interface component, a description of a first problem. The method includes assigning, by a clustering engine executing on the first computing device, the first problem to a class. The method includes identifying, by a correlation engine executing on the first computing device, a first database associated with the class. The method includes retrieving, by the correlation engine, from the identified database, first data relevant to the first problem. The method includes providing, by the first computing device, via the user interface component, a suggestion for solving the first problem, based on the retrieved first data.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C are block diagrams depicting embodiments of computers useful in connection with the methods and systems described herein;

FIG. 1D is a block diagram depicting one embodiment of a system in which a plurality of networks provide data hosting and delivery services;

FIG. 2 is a block diagram depicting an embodiment of a system for receiving a description of a problem and automatically solving the problem;

FIG. 3A is a flow diagram depicting an embodiment of a method for receiving a description of a problem and automatically solving the problem;

FIG. 3B is a flow diagram depicting an embodiment of a method for receiving a description of a first problem and automatically solving the first problem and an unidentified second problem;

FIG. 4 is a flow diagram depicting an embodiment of a method for receiving at least a portion of a problem description and applying machine learning to automatically complete at least one user interface component in an electronic form relating to the problem;

FIG. 5 is a flow diagram depicting an embodiment of a method for receiving support ticket data and applying machine learning to automatically identify a portion of the support ticket data for removal;

FIG. 6 is a flow diagram depicting an embodiment of a method for applying machine learning to modify a user interface displaying at least one task; and

FIGS. 7A-7B are block diagrams depicting embodiments of user interface elements that are modifiable based upon an instruction from a machine learning model.

### DETAILED DESCRIPTION

In some embodiments, the methods and systems described herein provide functionality for receiving a description of a problem and automatically solving the problem. Before describing these methods and systems in detail, however, a description is provided of a network in which such methods and systems may be implemented.

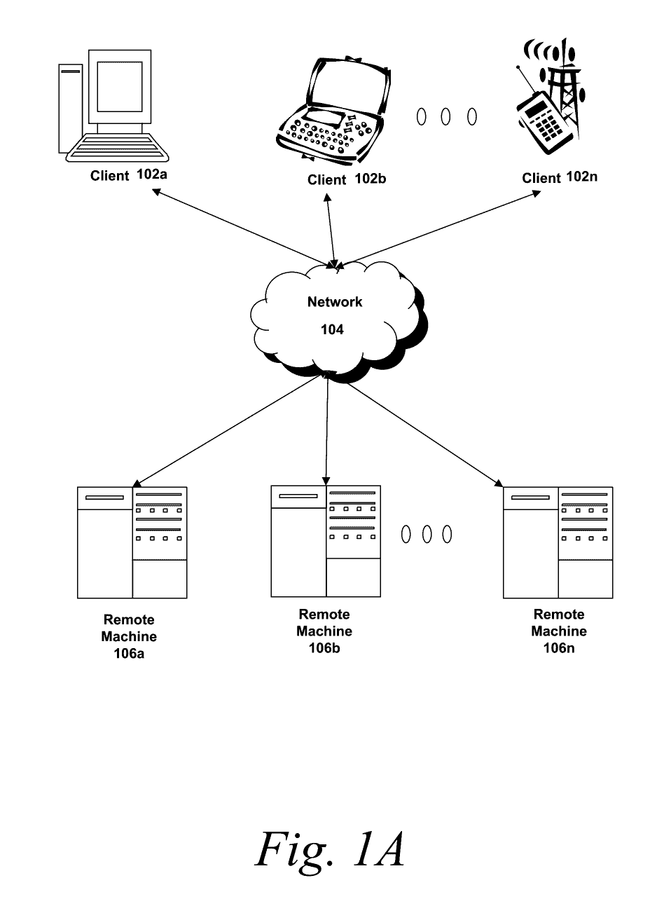

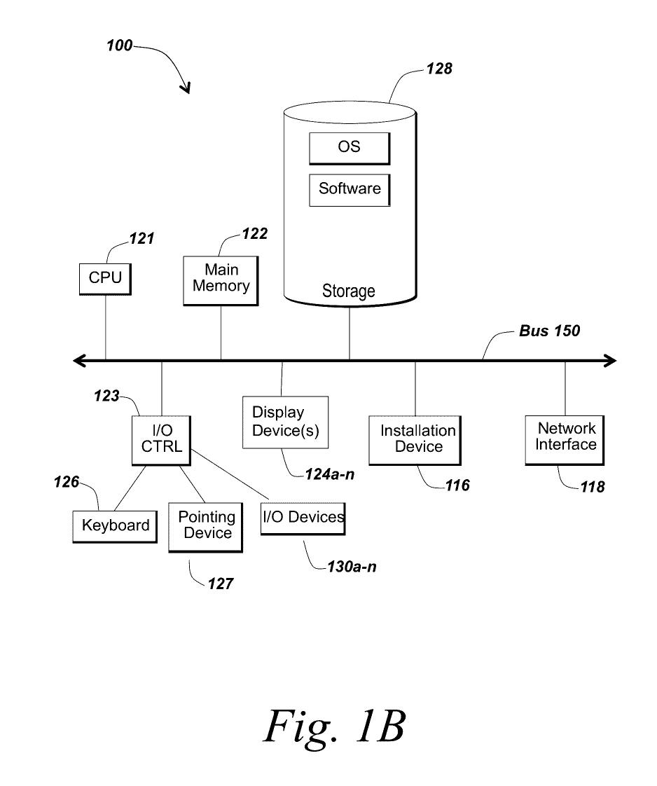

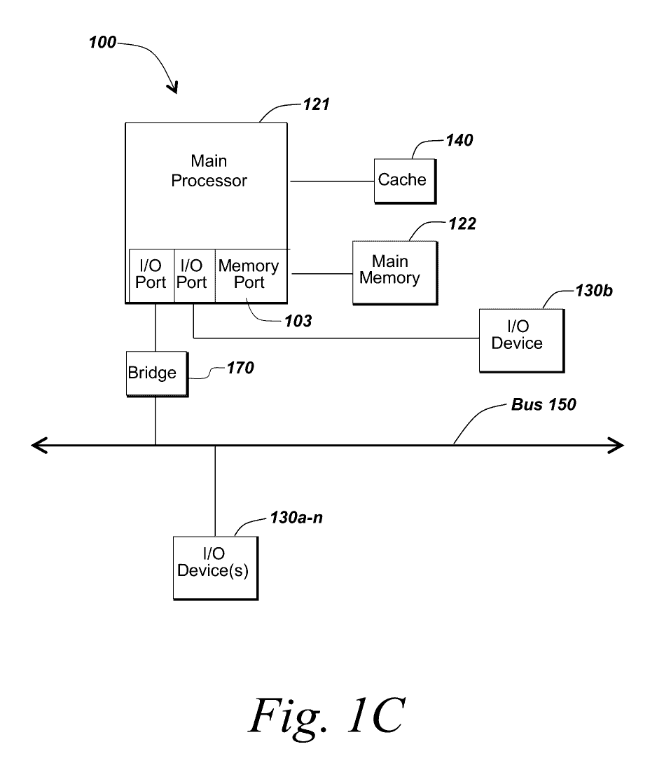

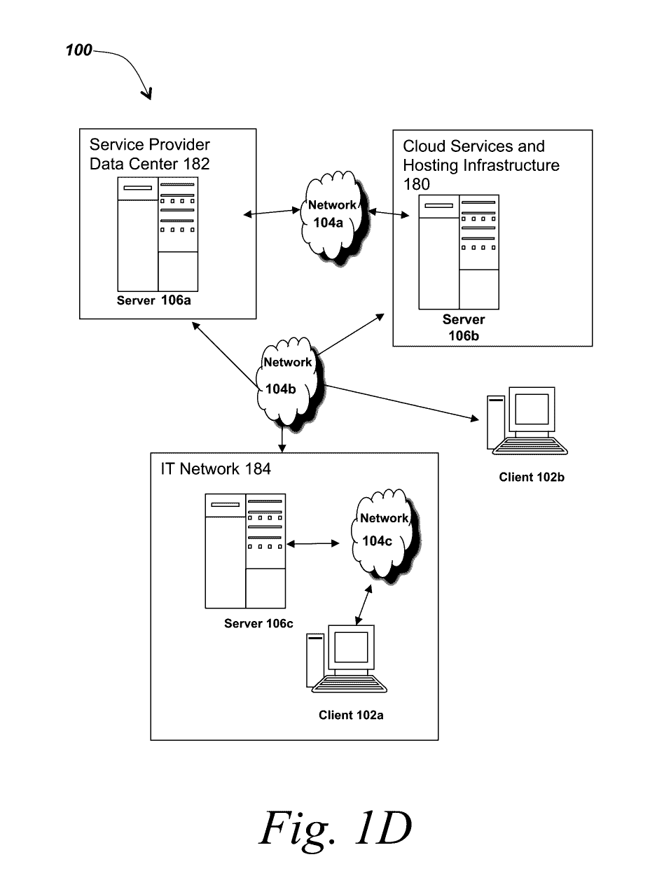

Referring now to FIG. 1A, an embodiment of a network environment is depicted. In brief overview, the network environment comprises one or more clients 102a-102n in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local area network (LAN), such as a company Intranet, a metropolitan area network (MAN), or a wide area network (WAN), such as the Internet or the World Wide Web. In other embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

In one embodiment, a computing device 106 provides functionality of a web server. In some embodiments, a web server 106 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, Wash., the Oracle IPLANET web server products provided by Oracle Corporation of Redwood Shores, Calif., or the BEA WEBLOGIC products provided by BEA Systems of Santa Clara, Calif.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. The I/O devices may be controlled by an I/O controller 123 as shown in FIG. 1B. Furthermore, an I/O device may also provide storage and/or an installation medium 116 for the computing device 100. Referring still to FIG. 1B, the computing device 100 may support any suitable installation device 116, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. The computing device 100 may further comprise a storage device, such as one or more hard disk drives or redundant arrays of independent disks, for storing an operating system and other software.

Furthermore, the computing device 100 may include a network interface 118 to interface to the network 104 through a variety of connections including, but not limited to, standard telephone lines, LAN or WAN links (e.g., 802.11, Ti, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, and WINDOWS VISTA, all of which are manufactured by Microsoft Corporation of Redmond, Wash.; MAC OS manufactured by Apple Inc. of Cupertino, Calif.; OS/2 manufactured by International Business Machines of Armonk, N.Y.; and LINUX, a freely-available operating system distributed by Caldera Corp. of Salt Lake City, Utah, or any type and/or form of a UNIX operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments, the computing device 100 is a mobile device, digital audio player, digital media player, or a combination of such devices. A computing device 100 may execute, operate or otherwise provide an application, which can be any type and/or form of software program or executable instructions, including, without limitation, any type and/or form of web browser, web-based client, client-server application, an ActiveX control, or a JAVA applet, or any other type and/or form of executable instructions capable of executing on the computing device 100.

Referring now to FIG. 1D, a block diagram depicts one embodiment of a system in which a plurality of networks provides hosting and delivery services. In brief overview, the system includes a cloud services and hosting infrastructure 180, a service provider data center 182, and an information technology (IT) network 184.

In one embodiment, the data center 182 includes computing devices such as, without limitation, servers (including, for example, application servers, file servers, databases, and backup servers), routers, switches, and telecommunications equipment. In another embodiment, the cloud services and hosting infrastructure 180 provides access to, without limitation, storage systems, databases, application servers, desktop servers, directory services, web servers, as well as services for accessing remotely located hardware and software platforms. In still other embodiments, the cloud services and hosting infrastructure 180 includes a data center 182. In other embodiments, however, the cloud services and hosting infrastructure 180 relies on services provided by a third-party data center 182. In some embodiments, the IT network 104c may provide local services, such as mail services and web services. In other embodiments, the IT network 104c may provide local versions of remotely located services, such as locally-cached versions of remotely-located print servers, databases, application servers, desktop servers, directory services, and web servers. In further embodiments, additional servers may reside in the cloud services and hosting infrastructure 180, the data center 182, or other networks altogether, such as those provided by third-party service providers including, without limitation, infrastructure service providers, application service providers, platform service providers, tools service providers, and desktop service providers.

In one embodiment, a user of a client 102 accesses services provided by a remotely located server 106a. For instance, an administrator of an enterprise IT network 184 may determine that a user of the client 102a will access an application executing on a virtual machine executing on a remote server 106a. As another example, an individual user of a client 102b may use a resource provided to consumers by the remotely located server 106 (such as email, fax, voice or other communications service, data backup services, or other service).

As depicted in FIG. 1D, the data center 182 and the cloud services and hosting infrastructure 180 are remotely located from an individual or organization supported by the data center 182 and the cloud services and hosting infrastructure 180; for example, the data center 182 may reside on a first network 104a and the cloud services and hosting infrastructure 180 may reside on a second network 104b, while the IT network 184 is a separate, third network 104c. In other embodiments, the data center 182 and the cloud services and hosting infrastructure 180 reside on a first network 104a and the IT network 184 is a separate, second network 104c. In still other embodiments, the cloud services and hosting infrastructure 180 resides on a first network 104a while the data center 182 and the IT network 184 form a second network 104c. Although FIG. 1D depicts only one server 106a, one server 106b, one server 106c, two clients 102, and three networks 104, it should be understood that the system may provide multiple ones of any or each of those components. The servers 106, clients 102, and networks 104 may be provided as described above in connection with FIGS. 1A-1C.

Therefore, in some embodiments, an IT infrastructure may extend from a first network—such as a network owned and managed by an individual or an enterprise—into a second network, which may be owned or managed by a separate entity than the entity owning or managing the first network. Resources provided by the second network may be said to be “in a cloud.” Cloud-resident elements may include, without limitation, storage devices, servers, databases, computing environments (including virtual machines, servers, and desktops), and applications. For example, the IT network 184 may use a remotely located data center 182 to store servers (including, for example, application servers, file servers, databases, and backup servers), routers, switches, and telecommunications equipment. The data center 182 may be owned and managed by the IT network 184 or a third-party service provider (including for example, a cloud services and hosting infrastructure provider) may provide access to a separate data center 182.

In some embodiments, one or more networks providing computing infrastructure on behalf of customers is referred to a cloud. In one of these embodiments, a system in which users of a first network access at least a second network, including a pool of abstracted, scalable, and managed computing resources capable of hosting resources, may be referred to as a cloud computing environment. In another of these embodiments, resources may include, without limitation, virtualization technology, data center resources, applications, and management tools. In some embodiments, Internet-based applications (which may be provided via a “software-as-a-service” model) may be referred to as cloud-based resources. In other embodiments, networks that provide users with computing resources, such as remote servers, virtual machines, or blades on blade servers, may be referred to as compute clouds or “infrastructure-as-a-service” providers. In still other embodiments, networks that provide storage resources, such as storage area networks, may be referred to as storage clouds. In further embodiments, a resource may be cached in a local network and stored in a cloud.

In some embodiments, some or all of a plurality of remote machines 106 may be leased or rented from third-party companies such as, by way of example and without limitation, Amazon Web Services LLC of Seattle, Wash.; Rackspace US, Inc. of San Antonio, Tex.; Microsoft Corporation of Redmond, Wash.; and Google Inc. of Mountain View, Calif. In other embodiments, all the hosts 106 are owned and managed by third-party companies including, without limitation, Amazon Web Services LLC, Rackspace US, Inc., Google Inc., and Microsoft Corporation.

In some embodiments, systems and methods for maintaining infrastructure components leverage third-party data generated on social media sites to monitor and maintain infrastructure components as well as to predict upcoming IT events. In one embodiment, a system for maintaining infrastructure components combines data from an IT data source with data from a social media site. In another embodiment, such a system also integrates user-generated data with the data from the IT data source and from the social media site. For example, the system may display a single user interface providing access to alerts as to a level of health or a level of availability of an IT component, to data from a social media site containing a keyword associated with or descriptive of the IT component, and to data generated by a user of the system, such as a status update generated by an administrator that maintains the IT component. In some embodiments, providing access to a data stream that combines data from multiple different data sources—such as alerts from monitoring services, warnings from monitored machines or software, and user-generated comments from social media sites—to a user, such as a network administrator, provides the user with an enhanced ability to review data relating to one or more monitored components and to take appropriate actions to proactively address technical issues.

In some embodiments, the methods and systems described herein provide functionality for applying machine learning to problem solving. In contrast with many conventional systems, the methods and systems described herein may receive text (e.g., in “natural,” human-readable language), automatically discern from the text the relevant keywords and identify a problem being described by the text (e.g., through the use of machine learning models), automatically identify databases containing information for solving that problem (for example, and without limitation, by applying machine learning models to identify substantially similar problems and identifying information in a variety of databases that were useful in solving those problems), automatically identify a resolution for the problem, and provide, without human intervention, the user with a suggestion for solving a problem.

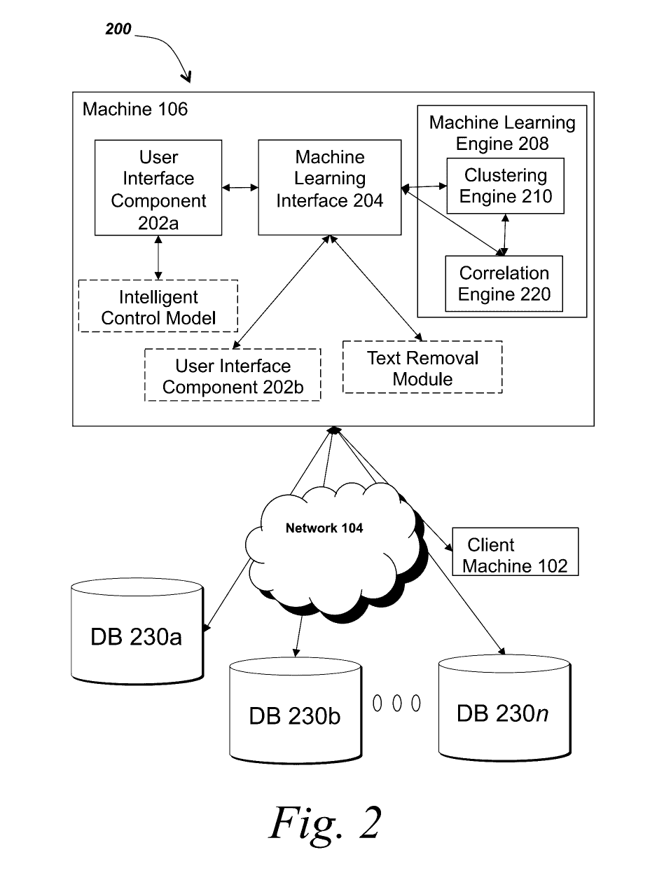

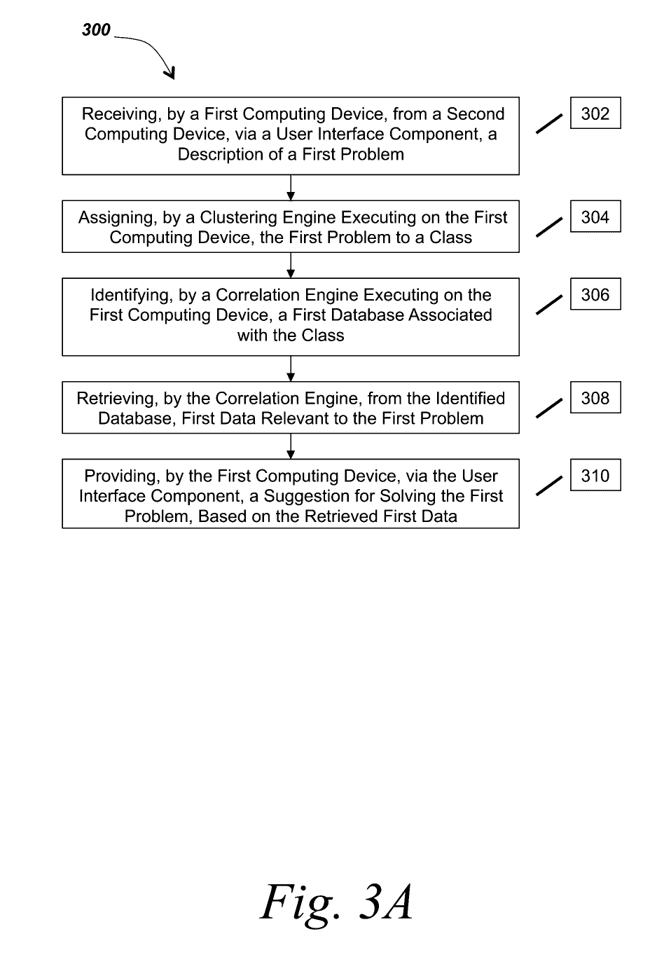

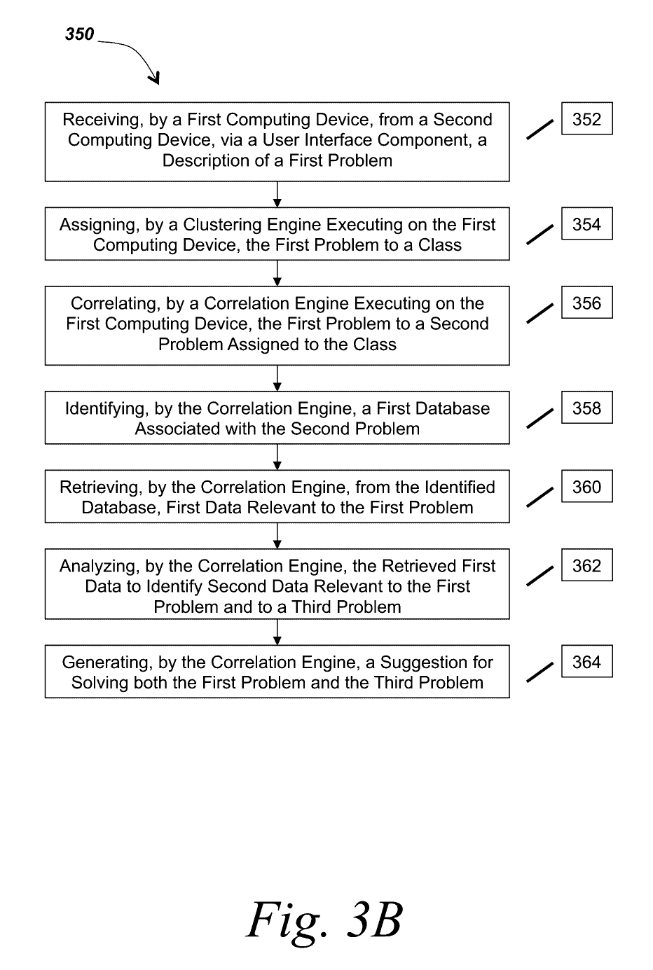

Referring now to FIG. 3A, in connection with FIG. 2, a flow diagram depicts one embodiment of a method 300 for receiving a description of a problem and applying machine learning to automatically solve the problem. In brief overview, the method 300 includes receiving, by a first computing device, from a second computing device, via a user interface component, a description of a first problem (302). The method 300 includes assigning, by a clustering engine executing on the first computing device, the first problem to a class (304). The method 300 includes identifying, by a correlation engine executing on the first computing device, a first database associated with the class (306). The method 300 includes retrieving, by the correlation engine, from the identified database, first data relevant to the first problem (308). The method 300 includes providing, by the first computing device, via the user interface component, a suggestion for solving the first problem, based on the retrieved first data (310).

In one embodiment, a machine 106 as described above in connection with FIGS. 1A-D executes the user interface component 202, the machine learning interface 204, the machine learning engine 208, the clustering engine 210 and the correlation engine 220. Although for ease of discussion, each of the user interface component 202, the machine learning interface 204, the machine learning engine 208, the clustering engine 210 and the correlation engine 220 are described as separate components executing on a single machine, it should be understood that this does not restrict the architecture to a particular implementation. For instance, these components may be encompassed by a single circuit or software function; alternatively, they may be distributed across a plurality of machines 106. Additionally, it should be understood that more than one of each component may be provided.

In another embodiment, the user interface component 202 is implemented in software. In still another embodiment, the user interface component 202 is implemented in hardware.

In another embodiment, the machine learning interface 204 is implemented in software. In still another embodiment, the machine learning interface 204 is implemented in hardware.

In another embodiment, the machine learning engine 208 is implemented in software. In still another embodiment, the machine learning engine 208 is implemented in hardware. Although described herein as including a clustering engine 210 and a correlation engine 220, one of ordinary skill in the art will understand that the machine learning engine 208 may include any one or more components that provide functionality for executing one or more machine learning algorithms. The machine learning engine 208 may include an ensemble of classifiers, for example. In an embodiment in which the machine learning engine 208 includes functionality for executing a clustering algorithm to identify patterns in data (e.g., the clustering engine 210), a variety of algorithms may be used, including, without limitation, K-Means and Expectation-Maximization algorithms. In an embodiment in which the machine learning engine 208 includes functionality for executing a classification algorithm to group data into classes (e.g., the clustering engine 210), a variety of algorithms may be used, including, without limitation, Random-Forests, Decision Trees, Support Vector Machines, Neural Nets, and Logistic Regression. As will be understood by one of ordinary skill in the art, other types of algorithms may also be used, including, without limitation, regression (linear and non-linear) and recurrent neural networks.

In another embodiment, the clustering engine 210 is implemented in software. In still another embodiment, the clustering engine 210 is implemented in hardware.

In another embodiment, the correlation engine 220 is implemented in software. In still another embodiment, the correlation engine 220 is implemented in hardware.

Referring now to FIG. 3A in greater detail, and still in connection with FIG. 2, the method 300 includes receiving, by a first computing device, from a second computing device, via a user interface component, a description of a first problem (302). In one embodiment, the user interface component 202 includes a user interface element (not shown) that allows users to enter a text-based description of the first problem. In another embodiment, the user interface component 202 includes a user interface element that allows users to dictate the description of the first problem (e.g., generate a spoken audio stream that may be recorded by the second computing device and decoded via the application of natural language processing by either the first computing device or the second computing device).

In one embodiment, the user interface component 202 receives the description of the first problem directly from a user of the first machine 106. In another embodiment, the machine 106 provides the client machine 102 with access to a user interface component 202 through which the user of the client machine 102 may provide the description of the first problem. In one embodiment, the user interface component 202 provides, to the machine 106, the description of the first problem and the machine learning interface 204 provides the description of the problem to the clustering engine 210. In yet another embodiment, the functionality of the user interface 202 is provided by the machine learning interface 204.

In one embodiment, the description of the first problem is unstructured text—that is, the user of the client machine 102 has entered a text-based description without formatting the description and the system will apply natural language processing or one or more machine learning models to analyze the unstructured input. In another embodiment, the description of the first problem is structured—that is, the user of the client machine 102 has entered the description according to a particular format or protocol or markup language. Although described in the examples below as a description of a technical support problem or a sales problem, the description of the problem may relate to any type of problem.

A description of a problem may include descriptions of any of a wide array of problems including those faced by organizations of any size. By way of example, a description of a problem may be a question of any type, including technical support questions, business questions, marketing questions, sales questions, and open-ended questions of any type; descriptions of problems may include questions such as “Why is my Internet access unavailable?” or “Why is this product not selling as well as we wanted it to?” or “Why has there been an increase in requests for support for this product?” As another example, the description of the problem may ask a prediction-type question, such as “To whom should I assign this trouble ticket?” or “How long will this issue take to resolve?”

In one embodiment, the machine learning interface 204 provides additional flexibility and ease-of-use for users of the methods and systems described herein. For example, and without limitation, the machine learning interface 204 may be configured to access one or more machine learning components of any type (e.g., the clustering engine 210 and the correlation engine 220) and receive some or all of an answer to one or more questions, without requiring users to interact with the underlying machine learning components. As another example, the machine learning interface 204 may be able to receive input from, for example, the user interface component 202 and may format the input into a format that is understandable by (e.g., able to be processed by) one or more machine learning components, without an administrator of the system having to modify the user interface component 202 to be able to perform that formatting function. Furthermore, the machine learning interface 204 may provide user interfaces simplifying the addition of databases 230a-n (referred to generally as databases 230) that are accessible to the machine learning components. For instance, the machine learning interface 204 may provide a user interface allowing a user to identify a database 230 and provide an identification of a type of data stored by the database 230. The machine learning interface 204 may, optionally, provide a user interface allowing a user to identify a type of problem the data in the database 230 may be useful in solving. The machine learning interface 204 may, optionally, provide a user interface allowing a user to identify a type of data within the database 230 that may be useful in solving a particular type of problem.

The method 300 includes assigning, by a clustering engine executing on the first computing device, the first problem to a class (304). In one embodiment, the clustering engine 210 applies a machine learning model (e.g., without limitation, a similarity engine) to identify at least one keyword in the description of the first problem with which the clustering engine 210 may identify a class to which to assign the description of the first problem. In still another embodiment, the clustering engine 210 assigns the first problem to a class including at least a second problem, the at least a second problem including the at least one keyword.

In one embodiment, the clustering engine 210 provides the description of the first problem and the assigned class to the correlation engine 220. In some embodiments, by determining a class of the first problem, the clustering engine 210 enables the correlation engine 220 to identify related databases, problems (e.g., problems of the same class), and problem resolutions.

In one embodiment, the clustering engine 210 uses machine learning to identify a class—or type—of problem being described in order to identify what resources (e.g., databases, machines, or people) to access in order to solve the problem, and any related, as-yet undescribed problems. In some embodiments, the clustering engine 210 performs a keyword identification to be able to identify what resources may be relevant. In some embodiments, the clustering engine 210 uses a variety of data, including user input via text, live data (e.g., streaming data), and voice data, to determine what type of data to look for.

In some embodiments, the clustering engine 210 has access to predefined feature selection templates allowing for more efficient installation processes while also including functionality for applying machine learning techniques to improve on the predefined feature selection templates. In other embodiments, the clustering engine 210 has already refined predefined feature selection templates when the clustering engine 210 receives the description of the first problem.

The method 300 includes identifying, by a correlation engine executing on the first computing device, a first database associated with the class (306). By way of example, and without limitation, the system may use system learning, manually inputted user data, data automatically generated or retrieved by the system, or any combination of these or other techniques to identify the first database.

In one embodiment, the correlation engine 220 queries a second database to identify the first database. By way of example, and without limitation, the correlation engine 220 may use the identified at least one keyword in a query of the second database for entries including the at least one keyword and receive an identification of any databases that are associated with those entries in the database. In another embodiment, the correlation engine 220 applies a machine learning model to identify a second problem to the class and identifies an association between the second problem in the class and the first database; the second problem may have at least one characteristic substantially similar to at least one characteristic of the first problem.

The method 300 includes retrieving, by the correlation engine, from the identified database, first data relevant to the first problem (308). In one embodiment, the correlation engine 220 queries a second database to identify the first data for retrieval. In still another embodiment, the correlation engine 220 applies a machine learning model to identify a second problem in the class (the second problem having at least one characteristic substantially similar to the at least one characteristic of the first problem) and identify the first data associated with the second problem and, optionally, with a resolution to the second problem. The correlation engine 220 may retrieve at least one historical event (e.g., data collected about a technical event occurring prior to the receipt of the description of the first problem) associated with the first problem and determine that the at least one historical event has at least one characteristic that is substantially similar to at least one characteristic of the second problem.

In one embodiment, the correlation engine 220 analyzes the retrieved first data to identify second data relevant to the first problem. In another embodiment, the correlation engine 220 applies a machine learning model to identify a second problem in the class, the second problem having at least one characteristic substantially similar to at least one characteristic of the first problem, and the correlation engine 220 identifies the second data associated with the second problem and, optionally, with a resolution to the second problem.

The correlation engine 220 may access one or more feature selection templates to identify data relevant to the first problem within the first database. By way of example, if the description included the text “Why is my Internet access unavailable?,” the clustering engine 210 may have identified “Internet access” and “unavailable” as keywords within the description and determined that the first problem is in a class of problems relating to Internet access. The correlation engine 220 may then access a database of problems mapped to classes of problems (e.g., databases mapped to classes relating to Internet access) to identify other problems in the class. The correlation engine 220 may determine, for example, that within a particular time period (e.g., the five-minute time period preceding the receipt of the description of the first problem), a number of new problems were added to the class, the number exceeding a particular threshold (e.g., 10x a normal number of new problems were added). The correlation engine 220 may use a feature selection template to determine a characteristic common across the problems within the class; by way of example, a feature selection template for problems in a class relating to Internet access may indicate that an Internet Protocol (IP) address of a client machine 102b (not shown) generating a complaint about Internet access is relevant. The correlation engine 220 may then retrieve—or request from the client machine 102—the IP address of the client machine related to the first problem. The correlation engine 220 may further analyze at least one related problem to determine other points of commonality—for example, the correlation engine 220 may determine that all problems of class “Internet access” added within five minutes of receiving the description of the first problem have IP addresses with a common characteristic such as all being IP addresses assigned to a particular geographic region or assigned by a particular sub-division of an organization. Through the use of feature selection templates and machine learning, the correlation engine 220 may identify and retrieve first data relevant to the first problem. In some embodiments, the correlation engine 220 analyzes how a feature contributes to an overall level of accuracy of a problem or question being asked. In other embodiments, the correlation engine 220 incorporates a user feedback loop to validate the system accuracy and allow for fine-tuning.

The method 300 includes providing, by the first computing device, via the user interface component, a suggestion for solving the first problem, based on the retrieved first data (310). In one embodiment, the correlation engine 220 accesses a database of solutions to previous problems of the same type to identify a solution. In another embodiment, the correlation engine 220 identifies a description of a resolution associated with a problem that is substantially similar to the first problem and provides the description of the resolution to the user interface component 202 for display to the user. In still another embodiment, the correlation engine 220 applies a machine learning model to identify a second problem in the class; identifies a resolution associated with the second problem; and determines that the resolution to the second problem resolves the first problem.

In one embodiment, the machine 106 automates an execution of the suggestion for solving the problem.

In one embodiment, the machine learning interface 204 receives an identification of a second database accessible for solving problems in the class; the machine learning interface 204 updates a database storing at least one association between the class of problems and at least one database accessible for solving problems in the class, to include an identification of the second database.

In some embodiments, the components described herein may execute one or more functions automatically, that is, without human intervention. For example, the system 200 may receive a description of a first problem (e.g., from a human or from another machine) and proceed to identify related problems and solutions with little or no human intervention. As another example, the system 200 may then proceed to automate executions of the identified solutions, again with little or no human intervention.

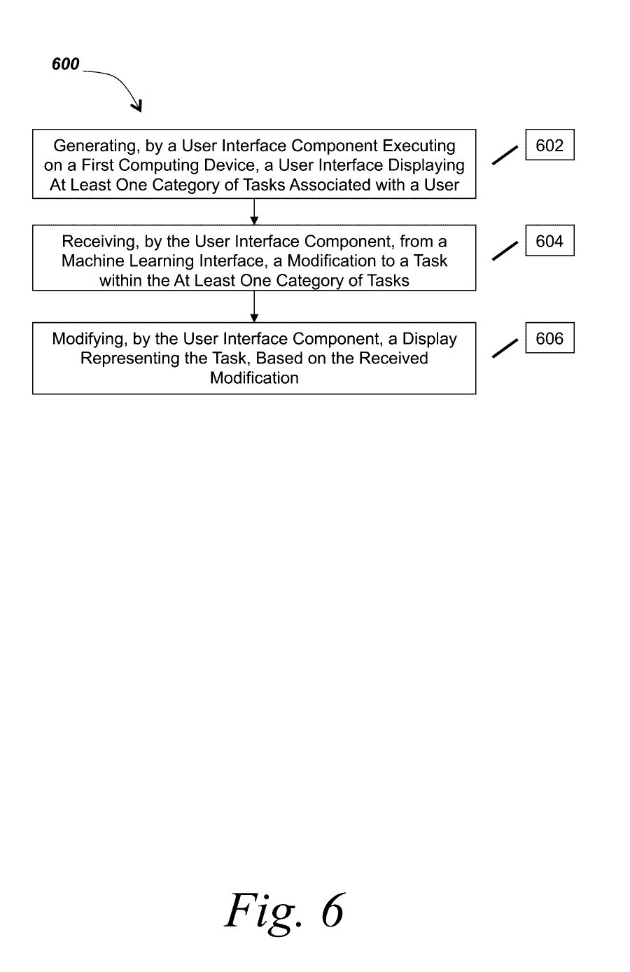

As will be discussed in greater detail below in connection with FIG. 6, the correlation engine 220 may identify modifications to be made to staff responsibilities as a result of identifying a solution to the first problem. By way of example, the correlation engine 220 may identify a task to be assigned to a user to implement the suggested solution. The correlation engine 220 may provide the identification of the task to the machine learning interface 204. The machine learning interface 204 may provide the identification of the task to a user interface component displaying at least one category of tasks associated with the user (e.g., the user interface component 202b depicted in shadow in FIG. 2). The user interface component may modify the user interface to include the received identification of the task. As another example, the correlation engine 220 may identify both a first task to be assigned to a user to implement the suggested solution and a modification of a level of priority of a second task associated with the user before identification of the first task. The machine learning interface 204 may transmit, to the user interface component displaying at least one category of tasks associated with the user, a modification of the level of priority of the second task and the identification of the first task. The user interface component may modify the user interface to include the identification of the task and the modified level of priority of the second task.

In some embodiments, the methods and systems described herein provide functionality for analyzing a received problem description and determining what seemingly unrelated systems or databases should be studied to identify related problems that should be solved to provide a solution, in whole or in part, to the received problem description. In contrast to other approaches, the methods and systems described herein are able to access a plurality of databases containing data of different types (e.g., data relating to human resources may be quite different from information technology (IT) call center data or customer relationship management data). In one of these embodiments, by allowing the systems to generate an integrated view of databases that were previously not accessible or accessible for limited purposes (e.g., record keeping), the systems described herein may develop a cohesive view of data across an organization, which enables functionality for deducing answers to even unasked questions.

Referring now to FIG. 3B, in connection with FIG. 2-3A, a flow diagram depicts one embodiment of a method 300 for receiving a description of a first problem and automatically solving the first problem and an unidentified second problem. In brief overview, the method 350 includes receiving, by a first computing device, from a second computing device, via a user interface component, a description of a first problem (352). The method 350 includes assigning, by a clustering engine executing on the first computing device, the first problem to a class (354). The method 350 includes correlating, by a correlation engine executing on the first computing device, the first problem to a second problem assigned to the class (356). The method 350 includes identifying, by the correlation engine, a first database associated with the second problem (358). The method 350 includes retrieving, by the correlation engine, from the identified database, first data relevant to the first problem (360). The method 350 includes analyzing, by the correlation engine, the retrieved first data to identify second data relevant to the first problem and to a third problem (362). The method 350 includes generating, by the correlation engine, a suggestion for solving the first problem and the third problem (364). The method 350 may optionally include automating, by the first computing device, execution of the suggestion.

Referring now to FIG. 3B in greater detail, and still in connection with FIG. 2, the method 350 includes receiving, by a first computing device, from a second computing device, via a user interface component, a description of a first problem (352). In one embodiment, the first computing device receives the description of the first problem as described above in connection with FIGS. 2-3A.

The method 350 includes assigning, by a clustering engine executing on the first computing device, the first problem to a class (354). In one embodiment, the clustering engine 210 assigns the class as described above in connection with FIGS. 2-3A.

The method 350 includes correlating, by a correlation engine executing on the first computing device, the first problem to a second problem assigned to the class (356). In one embodiment, the correlation engine 220 accesses a data structure mapping different classes with different problems. The correlation engine 220 may use a similar engine to identify similar problems.

The method 350 includes identifying, by the correlation engine, a first database associated with the second problem (358). By way of example, and without limitation, the system may use system learning, manually inputted user data, data automatically generated or retrieved by the system, or any combination of these or other techniques to identify the first database. The correlation engine 220 may identify the first database as described above in connection with FIGS. 2-3A.

The method 350 includes retrieving, by the correlation engine, from the identified database, first data relevant to the first problem (360). The correlation engine 220 may retrieve the first data as described above in connection with FIGS. 2-3A.

The method 350 includes analyzing, by the correlation engine, the retrieved first data to identify second data relevant to the first problem and to a third problem (362). In one embodiment, the correlation engine 220 determines a first type of the first data, determines a second type of the second data, and determines that the first data and the second data are the same type of data. In another embodiment, the correlation engine 220 may determine that the first data is numerical data formatted as a date (e.g., MM/DD/YYYY); the correlation engine 220 may then perform a search of databases for other data formatted as dates and retrieve the second data. In still another embodiment, having determined that the first data and the second data are of the same type, the correlation engine 220 then determines whether the second data is relevant to both the first problem and to a third problem.

The method 350 includes generating, by the correlation engine, a suggestion for solving both the first problem and the third problem (364). In one embodiment, the correlation engine 220 accesses a database of solutions to previous problems of the same type to identify a solution.

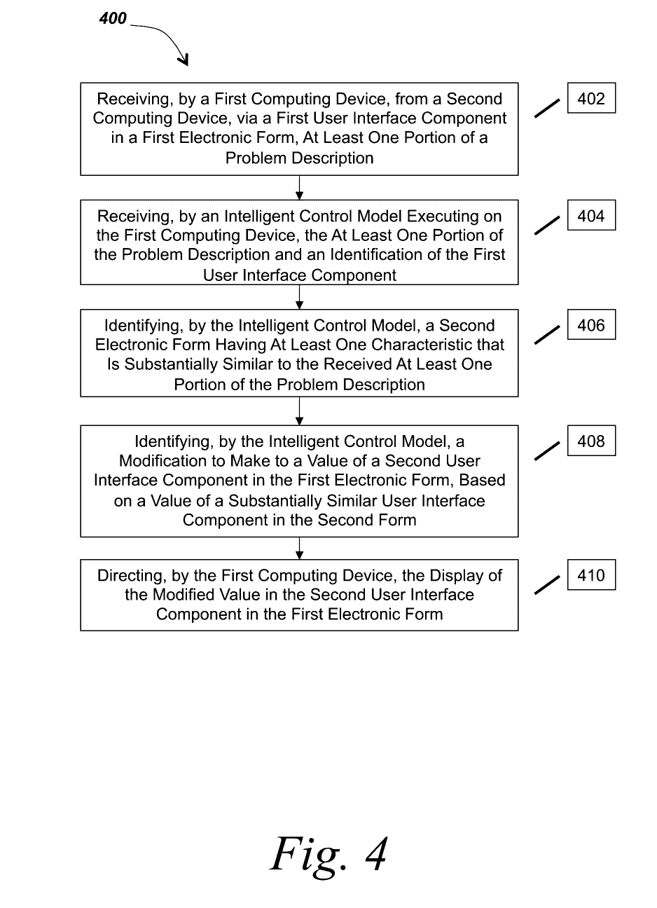

In some embodiments, the methods and systems described herein provide functionality for intelligent recommendation of values in user interface elements of any kind, including, without limitation, controls of any kind. Referring now to FIG. 4, and in connection with FIGS. 2 and 3A-B, a flow diagram depicts one embodiment of a method for receiving at least a portion of a problem description and applying machine learning to automatically complete at least one user interface component in an electronic form relating to the problem. The method 400 includes receiving, by a first computing device, from a second computing device, via a first user interface component in a first electronic form, at least one portion of a problem description (402). The method 400 includes receiving, by an intelligent control model executing on the first computing device, the at least one portion of the problem description and an identification of the first user interface component (404). The method 400 includes identifying, by the intelligent control model, a second electronic form having at least one characteristic that is substantially similar to the received at least one portion of the problem description (406). The method 400 includes identifying, by the intelligent control model, a modification to make to a value of a second user interface component in the first electronic form, based on a value of a substantially similar user interface component in the second form (408). The method 400 includes directing, by the first computing device, the display of the modified value in the second user interface component in the first electronic form (410).

The method 400 includes receiving, by a first computing device, from a second computing device, via a first user interface component in a first electronic form, at least one portion of a problem description (402). By way of example, and without limitation, the first electronic form may be a support form or questionnaire and a representative (e.g., at a call center or other support center) may fill in a portion of a user interface component in the electronic form with some or all of a description of a problem received (e.g., by a caller seeking support).

The method 400 includes receiving, by an intelligent control model executing on the first computing device, the at least one portion of the problem description and an identification of the first user interface component (404). The user interface component may begin providing text entered by a user to the intelligent control model as soon as the user enters the text and need not wait for the user to finish typing.

The method 400 includes identifying, by the intelligent control model, a second electronic form having at least one characteristic that is substantially similar to the received at least one portion of the problem description (406). The intelligent control model may transmit the at least one portion of the problem description to the system described in FIGS. 2, 3A-B. The clustering engine 210 may therefore receive, from the intelligent control model, the at least one portion of the problem description. The clustering engine 210 may assign the problem description to a class as described above in connection with FIGS. 2, 3A-B, even if the problem is incomplete. The correlation engine 220 may apply a machine learning model to identify a second problem description in the class, the second problem description having at least one characteristic substantially similar to at least one characteristic of the at least one portion of the problem description. The correlation engine 220 may identify the second electronic form, which may be associated with the second problem description. The correlation engine 220 may provide, to the intelligent control model, an identification of the second electronic form.

The method 400 includes identifying, by the intelligent control model, a modification to make to a value of a second user interface component in the first electronic form, based on a value of a substantially similar user interface component in the second form (408).

The method 400 includes directing, by the first computing device, the display of the modified value in the second user interface component in the first electronic form (410).

Unlike conventional systems, each of the user interface components in the form are in communication with the intelligent control model and their values are dependent upon the values of other user interface components. The level of communication and interdependency between the components allows the system to provide a more intelligent type of electronic form.

A conventional autocomplete system may use machine learning to determine that two values are interrelated—for example that when the value of a first user interface component is “Virginia” or “VA” and a value of a second user interface component is “22313,” the two values' components are more likely to be deemed correct by a user; however, such a system fails to leverage communication between the components and an intelligent control model or to apply machine learning models to identify other, seemingly disconnected, user interface components. In conventional forms, there is not typically any communication between components and a central component control model that leverages machine learning models to use a change in one value to identify different electronic forms that may be relevant and assesses those forms to identify values of still other components. Furthermore, the methods and systems described herein are not constrained to comparisons between values in a subset of fields in an electronic form but the intelligent control model, in conjunction with the machine learning interface 204, provides functionality for identifying substantially similar forms based on a content of the overall form in its entirety and then uses the identified, substantially similar forms to predict values of fields in the original form.

The methods and systems described herein not only allow for intelligent completion of existing forms but for the generation of new forms in which a designer of the form may specify for which components the intelligent control model should predict values. The first computing device may receive, from the second computing device, via a separate user interface for generating electronic forms, an identification of at least one user interface component in the first electronic form for which the intelligent control model should predict a value.

The methods and systems described herein may provide functionality for improving the accuracy of a machine learning model by improving the quality of data provided to the model. In one embodiment, the methods and systems described herein may provide functionality for receiving data and applying machine learning to automatically identify a portion of the data for removal, where removal of the portion of the data will improve the accuracy of a similarity search (e.g., a search for other data substantially similar to the edited data).

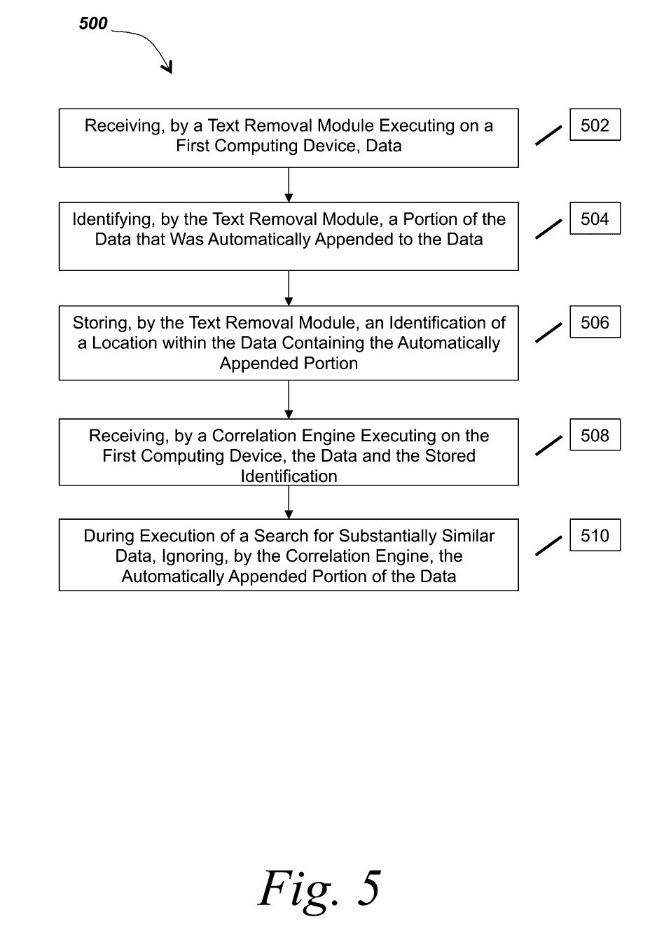

Referring now to FIG. 5, a flow diagram depicts one embodiment of a method for receiving data and applying machine learning to automatically identify a portion of the data for removal. The method 500 includes receiving, by a text removal module executing on a first computing device, data (502). The method 500 includes identifying, by the text removal module, a portion of the data that was automatically appended to the data (504). The method 500 includes storing, by the text removal module, an identification of a location within the data containing the automatically appended portion (506). The method 500 includes receiving, by a correlation engine executing on the first computing device, the data and the stored identification (508). The method 500 includes, during execution of a search for substantially similar data, ignoring, by the correlation engine, the automatically appended portion of the data (510).

The method 500 includes receiving, by a text removal module executing on a first computing device, data (502). By way of example, the text removal module may have access to one or more databases containing data, such as data that the correlation engine 220 will access to identify correlated or even substantially similar data to data received from a user (e.g., a description of a problem). The data may be support ticket data generated by a ticketing system (e.g., for tracking support calls received at a call center).

The method 500 includes identifying, by the text removal module, a portion of the data that was automatically appended to the data (504). By way of example, in an embodiment in which the data is support ticket data, the data may include a plurality of email messages exchanged between an individual requesting assistance and a support representative assisting the user; since all of the data may be relevant to solving the individual's question, a ticketing system is likely to have stored all of the data—including the email signature files that are automatically appended to each email the individual sends and to each email the support representative sends. Depending on the length of the email exchange and the length of the signature files, there may be the equivalent of many pages of text containing, without limitation, addresses, phone numbers, fax numbers, quotes, assistants' contact information, out-of-office auto-reply text, company logos, disclaimers, notices of confidentiality, requests to consider the environment before printing the email message, quotes (humorous, inspirational, or otherwise interesting to the individual sending the email), and even text arranged to create images when viewed by a human. These types of automatically appended data tend to be irrelevant to the problem being solved.

The text removal module may transmit the received data to a machine learning interface 204 for assistance in identifying the portion of the data that was automatically appended; the machine learning interface 204 may provide the data to the clustering engine 210 as described above in connection with FIGS. 2, 3A-B.

The clustering engine 210 may receive, from the text removal module, directly or indirectly, the data. The clustering engine 210 may assign the data to a class.

In some embodiments, the correlation engine 220 may analyze data to determine characteristics of the data such as, without limitation, whether there is a particular string of characters leading up to a separation in text, whether there is a particular string of characters following a separation in text, a number of words in the data, a number of words that start with capital letters, a number of lines in block formatting, an average length of a line of text, a position in a document relative to a start of the document, a position in a document relative to an end or bottom of the document, a number of words that exist in previously generated classes of words (e.g., a number of words that exist in a class of words that have previously been designated “boiler-plate ground-truth” or as “non-boiler-plate ground-truth”).

In other embodiments, the correlation engine 220 may apply a machine learning model to identify second data in the class, the second data having at least one characteristic substantially similar to at least one characteristic of the data. The correlation engine 220 may apply a heuristic to identify second data in the class, the second data having at least one characteristic substantially similar to at least one characteristic of the data. The correlation engine 220 may identify a location within the second data containing a second automatically appended portion (e.g., previously identified as containing the second automatically appended portion). The correlation engine 220 may identify a substantially similar location within the received data as containing the automatically appended portion. The correlation engine 220 may provide, directly or indirectly, to the text removal module, an identification of the location within the received data containing the automatically appended portion.

The method 500 includes storing, by the text removal module, an identification of a location within the data containing the automatically appended portion (506). By way of example, the text removal module may store an identification of line numbers at which a portion of automatically appended data begins. As another example, the text removal module may store an identification of a pattern preceding the portion of automatically appended data. The text removal module may store the identification of the location in any type or form of data structure.

The text removal module may request user feedback regarding the accuracy of the identified data. By way of example, the text removal module may generate a display to a user of the received text and may display the automatically appended portion in a different color, size, font, or other format than the remainder of the data; upon receiving user confirmation or denial of the accuracy of the identification, the text removal module may provide the user feedback to the machine learning interface 204 for incorporation into future data assessments.

The method 500 includes receiving, by a correlation engine executing on the first computing device, the data and the stored identification (508). The text removal module may provide the data and the stored identification to the correlation engine 220. Alternatively, the text removal module may include the stored identification in a database storing the data and the correlation engine 220 may retrieve the stored identification upon retrieval of the data for analysis.

The method 500 includes, during execution of a search for substantially similar data, ignoring, by the correlation engine, the automatically appended portion of the data (510). By way of example, if the stored identification indicates that lines 20-60 of the data are automatically appended data, the correlation engine 220 may search for data that is similar to lines 1-19 but ignore lines 20-60 for the purposes of a similarity search.

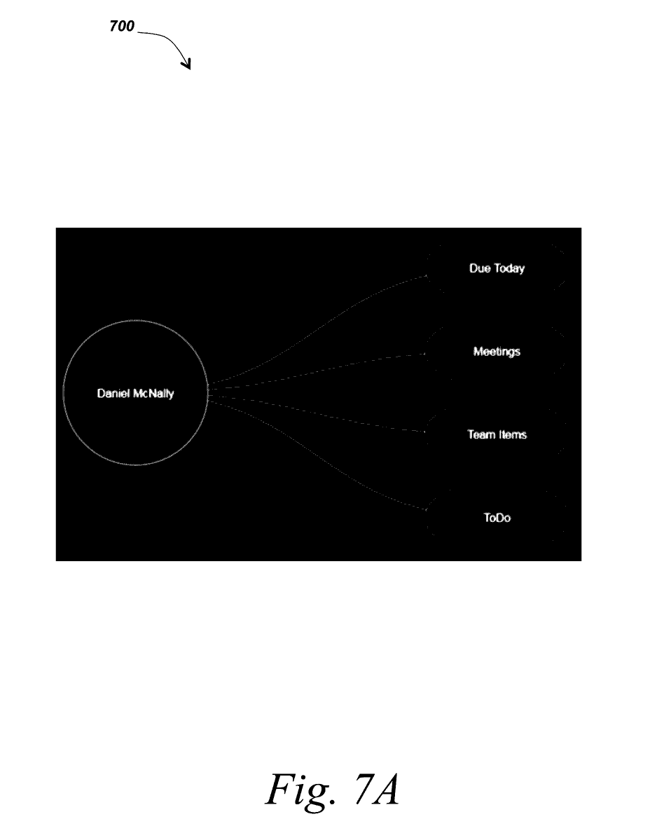

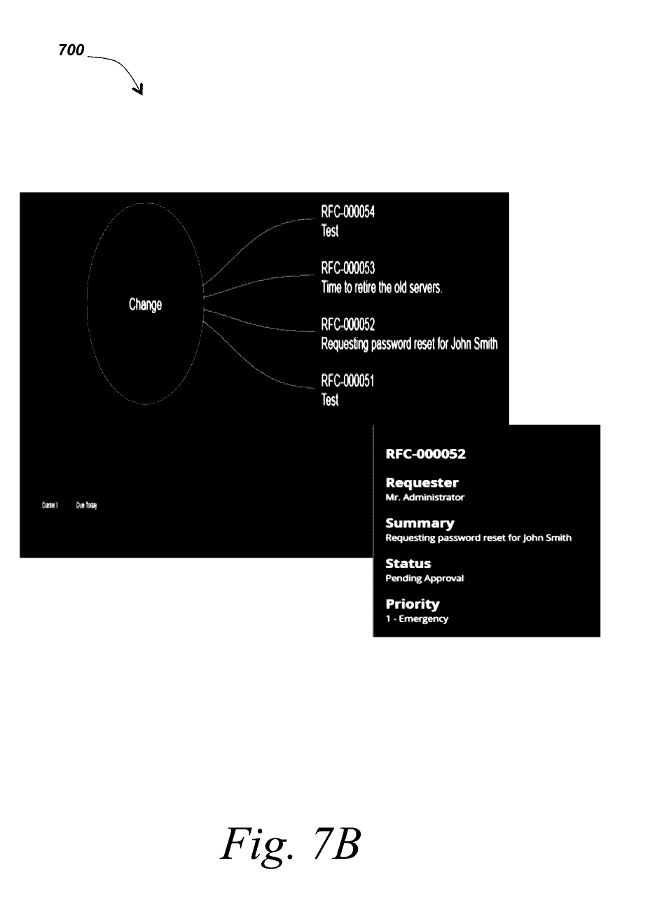

Referring now to FIG. 6, and in connection with FIGS. 7A-B, a flow diagram depicts one embodiment of a method 600 for applying machine learning to modify a user interface displaying at least one task. The method 600 includes generating, by a user interface component executing on a first computing device, a user interface displaying at least one category of tasks associated with a user (602). The method 600 includes receiving, by the user interface component, from a machine learning interface, a modification to a task within the at least one category of tasks (604). The method 600 includes modifying, by the user interface component, a display representing the task, based on the received modification (606).

The method 600 includes generating, by a user interface component executing on a first computing device, a user interface displaying at least one category of tasks associated with a user (602). As depicted in FIG. 7A, categories include, without limitation, tasks that are due by a particular date (e.g., “due today”), meetings, team items, and all tasks that are assigned to the user. As depicted in FIG. 7B, the user interface component may modify the display to provide additional detail regarding tasks within the at least one category. By way of example, and as shown in FIG. 7B, the user interface component may modify the display to include, without limitation, an additional display specifying a requester of the task, a summary of the task, a status of the task and a level of priority of the task.

The method 600 includes receiving, by the user interface component, from a machine learning interface, a modification to a task within the at least one category of tasks (604). In one embodiment, the correlation engine 220 identifies a solution to a described problem, as described above; the correlation engine 220 identifies the modification to be made to at least one task assigned to the user, based upon the identified solution and provides the identification of the modification directly or indirectly (e.g., via the machine learning interface 204) to the user interface component. The correlation engine 220 may have identified the modification by analyzing substantially similar solutions implemented for substantially similar problems and determined that the implementation included assigning a particular type of task to a particular type of user and then determining to make a similar assignment to solve the problem at issue. The correlation engine 220 may have determined to modify an existing task assigned to the user (e.g., modifying the priority level). The correlation engine 220 may have determined to assign a new task to the user. The correlation engine 220 may have identified the modification based on an analysis of a solution to a problem that is independent of (or unrelated to) an already assigned task, or based on an analysis of a solution to a problem that is associated with the already assigned task.

The user interface component may receive an indication of a modification to a level of priority of the task. The user interface component may receive an indication of a modification to a date on which the task is due. The user interface component may receive an indication of an assignment of a new task. The user interface component may receive an indication of a new meeting the user is to attend. The user interface component may receive an indication of an amount of time to be allotted for completing the task.

The method 600 includes modifying, by the user interface component, a display representing the task, based on the received modification (606). The user interface component may change the display representing the task so that the text is displayed in a different format. The user interface component may change the display representing the task so that the text is displayed in a different font. The user interface component may change the display representing the task so that the text is displayed in a different color. The user interface component may change the display representing the task by displaying a sequence of images.

Although described herein within the context of modifying a task, the functionality provided herein may be used to provide additional or alternative functionality. For example, by analyzing a stream of data associated with a particular user (including, without limitation, email data, calendar data, task data, customer relationship management data, or other data), and by providing assistance with prioritizing subsets of data within the stream of data and making recommendations and decision support, the methods and systems described herein provide functionality for improving efficiency, minimizing the impact of interruptions, and helping prioritize tasks.

As indicated above, the system 200 may modify an assignment provided to a user, creating a new assignment or modifying an existing assignment. The correlation engine 220 may derive assignment data from a solution identified in connection with a problem. In some embodiments, the question of which individuals to assign to a task is the problem—that is, the problem being solved is “What staffing assignments are necessary to implement a solution to another problem?”—and the system 200 works as described above in connection with FIGS. 2 and 3A-B to identify classes of problems (e.g., without limitation, human resources problems or staffing problems), and to identify a database associated with that class of problems (e.g., a database listing staffing assignments for a variety of problems), and retrieve data related to a second, substantially similar problem for use in identifying the staffing solution in this particular instance. In other embodiments, a staffing interface receives an indication of a task for which at least one staffing assignment is required. The clustering engine 210 and the correlation engine 220 identify, as described above, a second task for which a staffing assignment was required and identify at least one characteristic of a staffing assignment (e.g., without limitation, this type of staffing assignment requires that the staff have experience in handling email problems and that none of the individuals are already assigned to more than three tasks that are due today and that all of the individuals are scheduled to be in the office today). Examples of characteristics may include, without limitation, whether a given staff member is scheduled to be in the office or otherwise available for work during a given time period (which may involve analyzing calendaring data), a type of expertise, a level of expertise, a user's “solve rate” (or the rate at which they solve problems), a length of time similar problems have taken the user or group of users to solve, what type of problem the staff will be solving, the priority level of the problem being solved, and existing commitments for each staff member. Using the identified at least one characteristic, the correlation engine 220 may identify one or more staff members that satisfy the identified at least one characteristic and provides the identification to the staffing interface (directly or via the machine learning interface 204). The correlation engine 220 may also apply work load principles to determine which of a plurality of qualified staff members to assign—for example, by load balancing tasks, applying a round robin technique, or by applying other rules or heuristics to determine whether to assign a staff member to a task. The staffing interface may update assignments for each identified staff member, as well as update a user interface that manages each staff member's assignments. In some embodiments, the correlation engine 220 also makes recommendations for improving staff members' abilities—for example, by noting that the time a particular staff member needs to solve a problem is above a particular threshold or is considered deficient when compared to other staff members' performances and therefore the staff member may benefit from additional training. In other embodiments, the correlation engine 220 may also make recommendations regarding hiring requirements; for example, the correlation engine 220 may note that there are regularly insufficient qualified staff members for addressing a particular type of problem.

In some embodiments, the methods and systems described herein provide functionality for modifying a display of data available to an end-user (e.g., a customer of an entity implementing the methods and systems described herein). By way of example, and as indicated above, the system 200 may include a user interface with which a user of a client machine 102 may provide a description of a question. The user of the client machine 102 as described in previous examples was a member of an organization seeking to provide support for another user (e.g., the user was a support representative working for or affiliated with a company). However, the user of the client machine 102 may also be a customer seeking support for themselves from an external web site or the user of the client machine 102 may be an employee seeking support for themselves from an internal web site. By way of example, any type of user may indicate that they require additional assistance with a problem—for example, a technical problem such as a malfunctioning printer. Regardless of the type of assistance the user receives (whether conventional or of the type described herein), the systems and methods described herein may provide additional information to the user, based on data gleaned from the user's interaction with the user interface. For example, the user may have indicated that they have a particular model printer used with a particular type of personal computer; the machine learning interface 204 may receive that information from the user interface 202 and store it in databases accessible to the clustering engine 210 and the correlation engine 220. Continuing with this example, additional information may be stored about the user and her computing devices—for example, the user may have given authorization for a software application referred to as an agent to execute on her computer in order to improve customer support or internal technical support and the agent may provide information to the machine learning interface 204, such as what type of hardware and software the user is miming, what types of questions the user asks, and so on. The machine learning interface 204 may also independently gather information about the user, such as determining what type of role the user has inside or outside the company, what type of tasks are assigned to the user, and so on. The clustering engine 210 and the correlation engine 220 may later use that information to provide relevant updates to the user. For example, if the correlation engine 220 determines that to solve a particular problem, a software application needs to be updated, the correlation engine 220 may identify all users who have asked questions about or requested support for using the software application and may instruct the machine learning interface 204 to direct the transmission of a notification to each of those users indicating that the software application may be out of service at a particular time for updates. Additionally, the correlation engine 220 may take into consideration the type of users who interact with (as inferred by the fact that they asked questions about) the software application when scheduling the update—if the users tend to be high ranking officials or important customers or people that have a task due on a certain deadline, the correlation engine 200 may identify a solution for implementing the update to the software application at a time that does not negatively impact those users, or that minimizes the impact (again, by identifying substantially similar problems that required updating substantially similar software applications and determining when and how the update was scheduled so as to minimize or eliminate negative impacts).

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk or a removable disk. A computer may also receive programs and data from a second computer providing access to the programs via a network transmission line, wireless transmission media, signals propagating through space, radio waves, infrared signals, etc.

Having described certain embodiments of methods and systems for receiving a description of a problem and applying machine learning to automatically solve the problem, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for receiving a description of a problem and applying machine learning to automatically solve the problem, the method comprising:
receiving, by a first computing device, from a second computing device, via a user interface component, a description of a first problem;
assigning, by a clustering engine executing on the first computing device, the first problem to a class;
identifying, by a correlation engine executing on the first computing device, a first database associated with the class;
retrieving, by the correlation engine, from the identified database, first data relevant to the first problem; and
providing, by the first computing device, via the user interface component, a suggestion for solving the first problem, based on the retrieved first data.

2. The method of claim 1, further comprising:
providing, by the user interface component, to a machine learning interface, the description of the first problem; and
providing, by the machine learning interface, to the clustering engine, the description of the first problem.

3. The method of claim 1, wherein assigning further comprises applying, by a clustering engine executing on the first computing device, machine learning to identify at least one keyword in the description of the first problem.

4. The method of claim 1, wherein assigning further comprises assigning the first problem to a class, wherein the class includes at least a second problem including at least one keyword included in the description of the first problem.

5. The method of claim 1 further comprising providing, by the clustering engine, to the correlation engine, the description of the first problem and the assigned class.

6. The method of claim 1, wherein identifying further comprises querying a database to identify the first database.

7. The method of claim 1, wherein identifying further comprises:
applying, by the correlation engine, a machine learning model to identify a second problem in the class; and
identifying, by the correlation engine, an association between the second problem in the class and the first database.

8. The method of claim 1, wherein identifying further comprises identifying the second problem, the second problem having at least one characteristic substantially similar to at least one characteristic of the first problem.

9. The method of claim 1, wherein retrieving further comprises querying a database to identify the first data for retrieval from the first database.

10. The method of claim 1, wherein retrieving further comprises:
applying, by the correlation engine, a machine learning model to identify a second problem in the class; and
identifying, by the correlation engine, the first data associated with the second problem and with a resolution to the second problem.

11. The method of claim 10, wherein applying, by the correlation engine, the machine learning model further comprises:
retrieving at least one historical event associated with the first problem; and
determining that the at least one historical event has at least one characteristic that is substantially similar to at least one characteristic of the second problem.

12. The method of claim 1, wherein retrieval further comprises identifying the second problem, the second problem having at least one characteristic substantially similar to at least one characteristic of the first problem.

13. The method of claim 1 further comprising analyzing the retrieved first data to identify second data relevant to the first problem.

14. The method of claim 1, wherein analyzing further comprises:
applying, by the correlation engine, a machine learning model to identify a second problem in the class; and
identifying, by the correlation engine, the second data associated with the second problem and with a resolution to the second problem.

15. The method of claim 1, wherein retrieval further comprises identifying the second problem, the second problem having at least one characteristic substantially similar to at least one characteristic of the first problem.

16. The method of claim 1, wherein providing further comprises:
applying, by the correlation engine, a machine learning model to identify a second problem in the class;
identifying, by the correlation engine, a resolution associated with the second problem; and
determining that the resolution to the second problem resolves the first problem.

17. The method of claim 1 further comprising automating, by the first computing device, execution of the suggestion.

18. The method of claim 1 further comprising:
receiving, by the machine learning interface, an identification of a second database accessible for solving problems in the class; and
updating, by the machine learning interface, a database storing at least one association between the class of problems and at least one database accessible for solving problems in the class, to include an identification of the second database.

19. The method of claim 1, wherein receiving the description of the first problem further comprises receiving a description of a technical support problem.

20. The method of claim 1, further comprising:
identifying, by the correlation engine, a task to be assigned to a user to implement the suggested solution;
transmitting, by the machine learning interface, to a user interface displaying at least one category of tasks associated with the user, an identification of the task; and
modification of the user interface to include the identification of the task.

21. The method of claim 1, further comprising:
identifying, by the correlation engine, a first task to be assigned to a user to implement the suggested solution and a modification of a level of priority of a second task associated with the user before identification of the first task;
transmitting, by the machine learning interface, to a user interface displaying at least one category of tasks associated with the user, a modification of the level of priority of the second task and the identification of the first task; and
modification of the user interface to include the identification of the task and the modified level of priority of the second task.

22. A system for receiving a description of a problem and applying machine learning to automatically solve the problem, the method comprising:
a first computing device receiving, from a second computing device, via a user interface component, a description of a first problem;
a machine learning interface receiving the description of the first problem from the user interface component;
a clustering engine executing on the first computing device, receiving the description of the problem from the machine learning interface, and assigning the first problem to a class;
a correlation engine executing on the first computing device, identifying a first database associated with the class, and retrieving from the identified database, first data relevant to the first problem; and
providing, by the first computing device, to the second computing device, via the user interface component, a suggestion for solving the first problem, based on the retrieved first data.
